(19) United States
(12) Patent Application Publication
(10) Pub. No.: US 2025/0390493 A1
(43) Pub. Date: Dec. 25, 2025

(54) DYNAMICALLY LOADING GRAPH DATABASE FOR FAST QUERIES

(71) Applicant: Gomboc AI Inc., New York, NY (US)

(72) Inventors: Ian Amit, New York, NY (US); Matthew Sweeney, New York, NY (US)

(21) Appl. No.: 19/244,190

(22) Filed: Jun. 20, 2025

Related U.S. Application Data
(60) Provisional application No. 63/662,976, filed on Jun. 21, 2024.
(60) Provisional application No. 63/662,973, filed on Jun. 21, 2024.

(51) Int. Cl. G06F 16/2453; G06F 16/901

(52) U.S. Cl. CPC G06F 16/24537; G06F 16/9024

(57) ABSTRACT

A computer-implemented method for dynamically loading a graph database. The method includes providing a query interface to one or more web clients over a communications network. The method includes receiving, from at least one of the one or more web clients, a query via the query interface. Based on the query, executing one or more external calls to one or more data sources. The method includes implementing one or more nodes-related methods to process node data from the one or more data sources. The method includes implementing one or more relationships-related methods to process relationship data from the one or more data sources. The method includes performing Create, Read, Update, Delete (CRUD) operation on data from the one or more data sources and constructing a graph database based on the results of the at least one CRUD operation.

### CROSS-REFERENCE TO RELATED APPLICATIONS

This application claims priority to U.S. Provisional App. No. 63/662,973, filed Jun. 21, 2024, and U.S. Provisional App. No. 63/662,976, filed Jun. 21, 2024, the disclosures of which are incorporated by reference herein in their entirety.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Traditional graph databases are software tools that encode graph and graph-like data, and can be designed to store the relationships between data as well as the data itself. Graph databases often contain nodes and edges. Nodes may represent entities in the graph database, such as individual records, individuals, computer resources, pieces of data, etc. Edges may be links or relationship connecting nodes to one another, representing how different pieces of data may be related. For example, social media connections can be stored as a graph with entities in the social media database stored as nodes in the graph and relationships between those entities (e.g., following, friends, etc.) may be edges between the nodes. Both nodes and edges may have properties, which may be additional information pertaining to them (e.g., name, age, etc.).

Graph databases may be useful in allowing for relatively quick traversal and management of complex relationships within data. Some applications where graph databases can be useful are social networks, recommendations engines, fraud detection, etc., where relationships between data may be as important as the individual data points themselves. However, writing data to a graph database is traditionally a slow process that may encode internal optimization at query time. This process does not enable real-time data availability in a timely manner (i.e., write speed may be too slow). Additionally, the general nature of traditional graph traversal cannot leverage graph structure properties to accelerate traversal. Finally, graph databases, as with other traditional databases, often use dedicated persistent storage to store database objects and graph structure that may persist beyond individual query executions.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a computer-implemented method for dynamically loading a graph database. The method may include providing, by one or more processors, a query interface to one or more web clients over a communications network. The method may include receiving, from at least one of the one or more web clients, a query via the query interface. Based on the query, the method may include executing, by the one or more processors, one or more external calls to one or more data sources. The method may include implementing, by the one or more processors, one or more nodes-related methods to process node data from the one or more data sources and implementing, by the one or more processors, one or more relationships-related methods to process relationship data from the one or more data sources. The method may include performing, by the one or more processors, at least one of Create, Read, Update, Delete (CRUD) operation on data from the one or more data sources and constructing, by the one or more processors, a graph database based on the results of the at least one CRUD operation.

In another embodiment, the disclosure describes a non-transitory computer-readable storage medium containing instructions for a method of dynamically loading a graph database. The method may include providing a query interface to one or more web clients over a communications network. The method may include receiving, from at least one of the one or more web clients, a query via the query interface. Based on the query, the method may include executing one or more external calls to one or more data sources. The method may include implementing one or more nodes-related methods to process node data from the one or more data sources, and implementing one or more relationships-related methods to process relationship data from the one or more data sources. The method may include performing at least one of Create, Read, Update, Delete (CRUD) operation on data from the one or more data sources and constructing a graph database based on the results of the at least one CRUD operation.

In another embodiment, the disclosure describes a computer-implemented method for dynamically loading a graph database. The method may include receiving, from one or more web clients, an API request with a data payload including query data. In response to receiving the API request, the method may include executing, by the one or more processors, one or more external calls to one or more to one or more heterogeneous data sources data sources based on the query data. The method may include receiving, by the one or more processors, results of the one or more external calls. The method may include constructing, by the one or more processors, a graph database based on the results of the one or more external calls. The method may include storing, by the one or more processors, the graph database in non-persistent storage.

### BRIEF DESCRIPTION OF THE DRAWINGS

The novel features that are considered characteristic of the disclosure are set forth with particularity in the appended claims. The invention itself; however, both as to its structure and operation together with the additional objects and advantages thereof are best understood through the following description of one or more embodiments of the present disclosure when read in conjunction with the accompanying drawings. The components in the figures are not necessarily to scale, emphasis instead being placed upon illustrating the principles of the disclosure. In the figures, like reference numerals designate corresponding parts throughout the different views, wherein:

FIG. 1 is a diagram illustrating an embodiment of a graph database structure in accordance with the disclosure;

FIG. 2 is a block diagram of an embodiment of a dynamically loading graph database system in accordance with the disclosure;

FIG. 3 is a flow chart illustrating and embodiment of a method of operating the dynamically loading graph database system in accordance with the disclosure;

FIG. 4 is a schematic illustration of elements of an embodiment of an example computing device; and

FIG. 5 is a schematic illustration of elements of an embodiment of a server type computing device.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure will now be described more fully hereinafter with reference to the accompanying drawings, which form a part hereof, and which show, by way of illustration, specific exemplary embodiments by which the disclosure may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Throughout the disclosure and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the disclosure.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In some embodiments, the disclosure describes a system and method for providing a dynamically loading graph database. In some embodiments, the dynamically loading graph database does not use persistent storage, but instead may implement a software mechanism that may dynamically discover nodes and relationships of a graph database. In some embodiments, the dynamically loading graph database may signal, to a traversal algorithm, hints of the graph database's underlying data structure at query time rather than at write-plus-query time. The dynamically loading graph database described herein may provide particular benefits in use cases where real time data may be changing relatively quickly (i.e., at a rate that may be faster than the writing of the data to storage), and/or when a graph database structure may be weakly connected (i.e., few incoming/outgoing arcs per node relative to the total number of objects/nodes in the graph).

Accordingly, in some embodiments, the dynamically loading graph database may provide a technical solution to technical problems related to inefficiencies in querying data stored in graph databases or similar forms. For example, traditionally, writing to a graph database may be a relatively slow process that may encode internal optimization at query time. Such a process may not enable real-time availability of data in a timely manner because the write speed may be too slow. Additionally, traditional graph traversal algorithms may not have the ability to leverage the structure of the graph database to accelerate traversal. In some embodiments, the dynamically loading graph database may implement a less generic traversal algorithm that may leverage graph database structure to accelerate traversal.

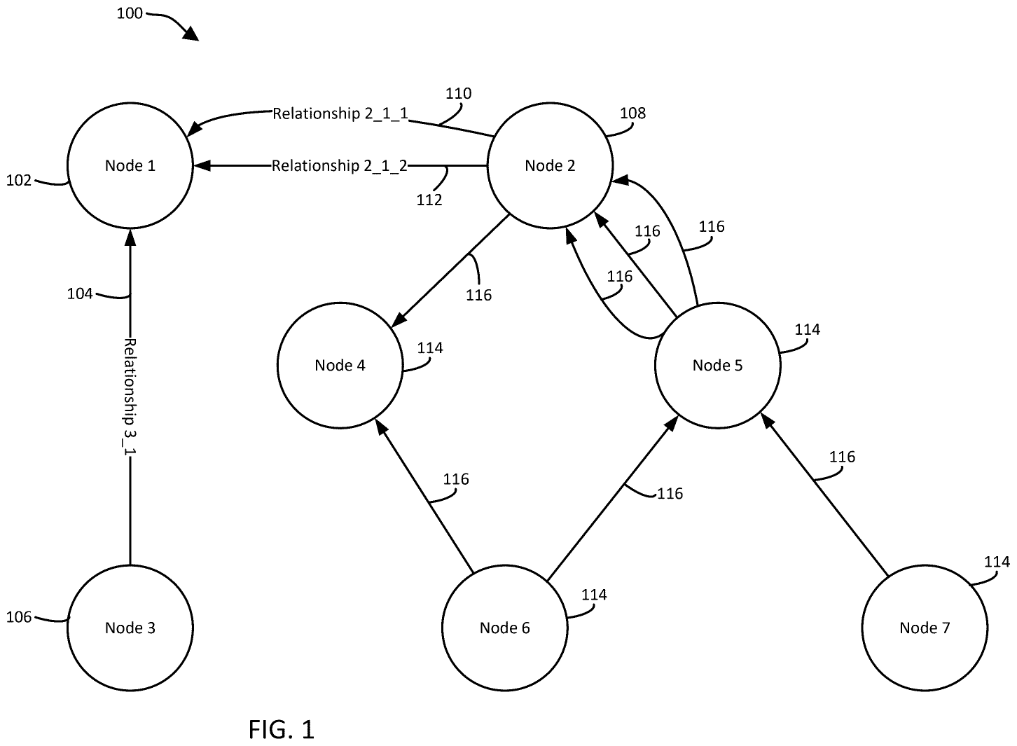

FIG. 1 shows a diagram illustrating an example of a graph database structure 100 for which the disclosed dynamically loading graph database may be implemented. The graph database 100 may include a plurality of nodes or object that may be connected by edges, which may define relationships between the nodes. For example, a first node 102 may be connected to a third node 106 by edge 104. Edge 104 may represent Relationship 3_1 between the first node 102 and the third node 106. The first node 102 and the third node 106 may be any of a variety of object or entities in a graph database, such as a user, a software application, a customer, a business, a database, etc. In an example embodiment where the first node 102 may be a user and the third node 106 may be a business, Relationship 3_1 104 may represent that the user (first node 102) is a member of the business (third node 106). Similarly, the second node 108 may be connected to the first node 102 via one or more edges 110, 112, which may each represent distinct relationships between the first node 102 and the second node 108. The rest of the graph 100 may include additional nodes 114 that may be connected by additional edges 116. Those skilled in the art will understand that, while FIG. 1 shows seven nodes and connections between those nodes, a graph database may include any number of nodes and connections between those nodes while still relevant to the disclosure.

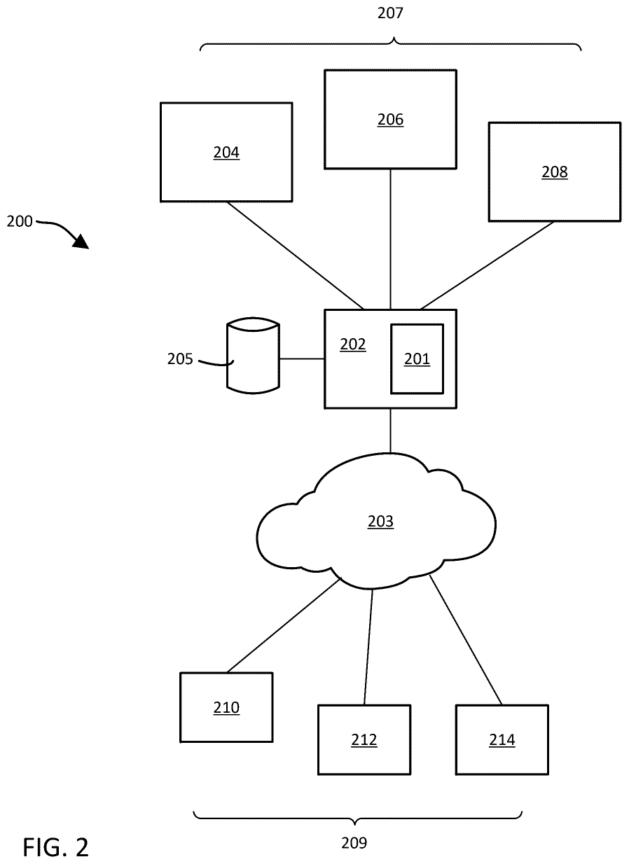

Graph databases may use various external data sources storing data that may be integrated into the graph database. For example, some graph databases may use or integrate data from relational databases, NoSQL databases, APIs to external services (e.g., social media platforms, financial services, etc.), big data platforms, etc. FIG. 2 shows a block diagram of an example dynamically loading graph database system 200 that may be used to implement the dynamically loading graph database described herein. The system 200 may include a dynamic graph application server 202 that may, in some embodiments, be configured to execute software instructions as described herein to run a dynamic graph application 201. In some embodiments, the dynamic graph server 202 may include or may be connected or otherwise in communication with a graph storage database 205. In some embodiments, the dynamic graph application server 202 may be configured, via the dynamic graph application 201, to store in the graph storage database 205 one or more graphs, subgraphs, data models, etc., such a graph database 100. In some embodiments, the storage of graphs or data models may be non-persistent or ephemeral as described herein. Those skilled in the art will understand that the graph storage database 205 may be included in the dynamic graph application server 202, or maybe located remotely to the server and/or accessed through a network such as communications network 203. Communications network 203 may be a wide area network (e.g., the Internet) that may connect to virtually any number of computer devices, servers, cloud servers, etc.

In some embodiments, the dynamic graph application server 202 may connect (either directly or through a network such as network 203) to one or more external data sources 207, either directly or through the communications network 203. In some embodiments, the one or more data sources 207 may be servers, cloud storage facilities, databases, or virtually anything connectable to the network 203 that may store or update data related to a graph database. For example, the one or more data sources may include relational databases 204, NoSQL databases 206, one or more APIs 208 that may provide data from social media platforms and other web services. Those skilled in the art will recognize that this list of potential external data sources 207 is not limited to those described in the disclosure, and that may include any data sources suitable for inclusion in a graph database or the dynamically loading graph database system 200 described herein.

In some embodiments, the system 200 may include one or more web clients 210, 212, 214 (collectively web clients 209). The web clients may be configured to connect to the dynamic graph application server 202 via the communications network 203. In some embodiments, the web clients 209 may be one or more individual computer devices (such as computing device 55), networks, one or more server type devices (such as server 57), or may be any other suitable computing platform. In some embodiments, the web clients 209 may be associated with user of the dynamic graph application 201 that may interface with the server 202 via one or more of web applications, native applications, APIs, user interfaces (UIs), graphical user interfaces (GUI), etc., as described herein.

In some embodiments, the dynamic graph application 201 may access heterogeneous data sources, such as external third-party APIs (e.g., external data source 208), internally produced data (such as stored in the graph storage database 205), live data feeds from other external data sources 207, etc. In some embodiments, the rate of change for the data stored at these heterogeneous data sources may vary widely per source or per data type. Due to the data's variable rate of change, traditional graph databases may include confirming or at least taking into account how recent the data in the graph database may have been sourced, and queries for that data may need to account for particular data sources, write times, and rate of change.

In contrast, in some embodiments, the dynamic graph application 201 may source data on demand. In such embodiments, the rate of change of the sourced data may be irrelevant because the data may be sourced only upon receiving a query, which may ensure up-to-date data sourcing. Additionally, because the dynamic graph application 201 sources data on demand, queries for data may be written in a data agnostic way. In other words, because the application 201 need not take into account whether the sources of date (e.g., the external data sources 207) may be fast-changing, slow-changing, or persistent, so the queries need not take the particular data source into account. Using data agnostic queries may accelerate performance in some embodiments.

The accelerated performance may be particularly improved when: (a) data sources may be updating very quickly and in an unpredictable fashion, which may make retrieving data on-request or on-demand more desirable; and (b) the graph structure being quired may be weakly connected. In some embodiments, weakly connected graphs may be graph databases in which there may be few incoming/outgoing arcs per node relative to the total number of objects in the graph). In both scenarios (a) and (b), it may be advantageous to use lazy loading of objects. In some embodiments, lazy loading may be when objects or nodes of a graph database may not be loaded all at once, but instead loaded on-demand, in a pattern, or by some other performance optimization timing. Cycles may refer to paths that start and end at the same node, traversing through other nodes without repeating any node except the starting/ending node. Lazy loading may be advantageous to scenarios like (a) and (b) because when there may be relatively few cycles in the graph database (if any), most objects may be encountered only once (if at all), which may make lazy loading relatively more efficient.

Additional advantages to the dynamic graph application 201 will be apparent to those skilled in the art. For example, in some embodiments, the external data sources 207 may be of arbitrary structure and the dedicated client (i.e., provider) may guarantee global unicity of object IDs in the graph database. In some embodiments, the dynamic graph application 201 may not use dedicated persistent storage. In some embodiments, the dynamically loading graph database may signal, to traversal algorithms, hints of the underlying data structure at query time rather than at write+query time. This may yield much higher performance during querying and graph traversal, and may use a less generic traversal algorithm.

Further, many traditional graph databases may focus on internal implementations. In some embodiments, the dynamic graph application 201 disclosed herein may focus on data modeling by foregoing explicit data writing in an internal data storage with a uniform data representation. By doing so, the dynamic graph application 201 may implement a just-in-time data conversion from the external sources 207 to internal representation on the fly, which may enable maximal data recency and increased query speeds.

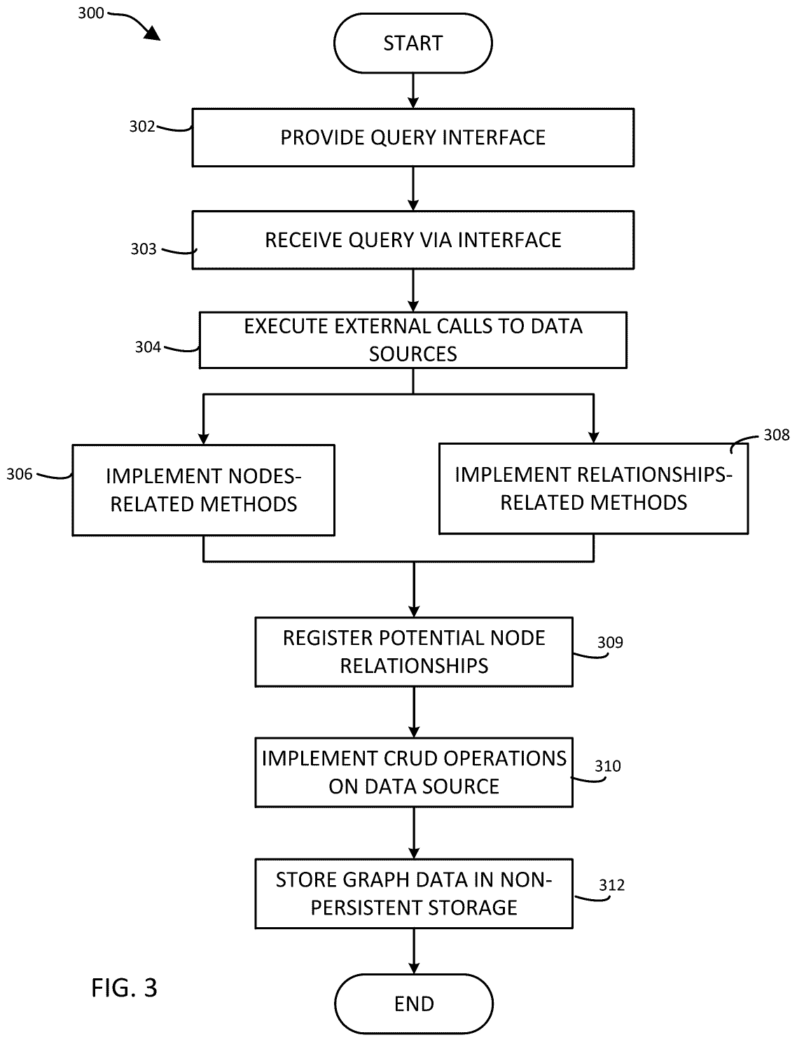

FIG. 3 is a flow chart of an embodiment of a method 300 for operating the dynamically loading graph database disclosed herein, such as via the dynamic graph application 201. In some embodiments, the dynamic graph application 201 may be a python program or similar, and may implement a graph traversal algorithm. In some embodiments, the traversal algorithm may, at 302, provide a query interface that may comply to a particular graph query language, such as openCypher specification, for example.

In some embodiments, the dynamic graph application 201 may receive, at 303 queries from the one or more web clients 209 via the query interface. In some embodiments, the queries may be received as API requests through a dynamic graph API, which may be configured to run on the dynamic graph application server 202. In some embodiments, queries or requests submitted via the dynamic graph API may include API requests with a data payload (e.g., JSON, XML, etc.). The data payload may, in some embodiments, include the query itself or data representing the query. Such API requests may be configured to expect an algorithmically derived response that may require a graph database query resolution.

At 304, the method may include executing one or more external calls to one or more data sources, such as the one or more external data sources 207. In some embodiments, the dynamic graph application 201 may be supplied python clients (e.g., HTTP clients, database clients, API clients, etc.) and may implement a formal data interface that may service the data via calls to one or more of the external data sources 207 (e.g., a call to a MySQL database, to an HTTP RESTful API, etc.).

In some embodiments, the client may implement one or more nodes-related methods (i.e., software functions) at 306 and one or more relationships-related methods at 308. In some embodiments, the nodes-related methods may focus on individual entities (e.g., nodes), while the relationship-related methods may focus on the connections between entities (e.g., edges or relationships). For example, in some embodiments, the dynamic graph application 201 may implement up to nine nodes-related methods and up to seven relationships-related methods, but the numbers for each may very in different embodiments.

In some traditional graph databases, faster query time execution may be optimized at the expense of longer initial time to store data. Such systems store as many relationships between the data as possible to in service of a breadth of graph querying and traversal, but lose time in initial data storage of all those relationships. In some embodiments of the method 300, a data discovery process during implementation of the traversal algorithm may include registration of a potentially existing relationship between nodes at 309. In other words, nodes may be, by default, disconnected in the data. But for a registered link type, one or more relationships may indeed exist between nodes. Such relationships may be discoverable, such as when the dynamic graph application 201 implements the appropriate nodes-related methods and relationship-related methods to retrieve the data from the external data sources. Because, in some embodiments, relationships existence defaults to nonexistent unless registered, traversal may be faster. In some embodiments, the traversal algorithm may register only the types of edges/relationships that may be necessary or may allow for the knowledge graph to be described, and may only include a relatively small or minimized set of query constructs. Such a setup may enable the dynamic graph application 201 to load the graph very quickly and have high-performing query execution as well.

At 310, each of the functions (16 total in the example) may implement CRUD (CREATE READ UPDATE DELETE) operations on the underlying data source. In some embodiments, the CRUD operations may to manipulate and retrieve graph construct information from the graph. The queries may be Cypher queries, and may return a ResultSet which contains a table of (node1->relationship (edge)->node2) tuples. While, in some embodiments, specific operations of the CRUD operations may be optional, some operations may be expected for usefulness. For example, in some embodiments or queries, some data sources may be read-only and therefore may not implement create, update, delete. Also, some specific data sources may make implementation of some specific methods difficult, undesirable, or in some cases implausible or even impossible. In some embodiments, at 312, the method may include storing graph data in non-persistent storage based on the CRUD operations.

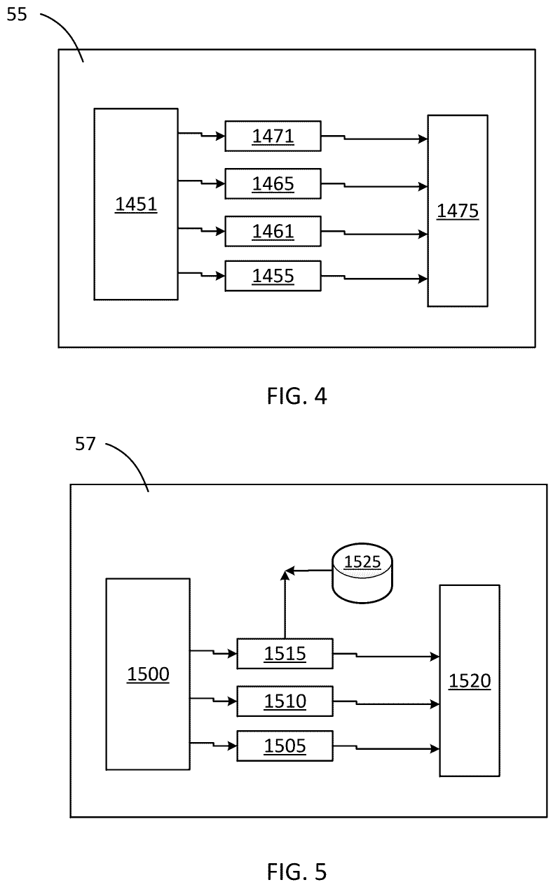

FIG. 4 is a simplified illustration of some physical elements that may make up an embodiment of a computing device 55 and FIG. 5 is a simplified illustration of the physical elements that make up an embodiment of a server type computing device, both of which may be used to run one or more aspects of the dynamic loading graph database system described herein. Referring to FIG. 4, a sample computing device is illustrated that is physically configured to be part of the systems and method for the dynamically loading graph database system. The computing device 55 may have a processor 1451 that is physically configured according to computer executable instructions. In some embodiments, the processor may be specially designed or configured to optimize communication between a server relating to the dynamic loading graph database system described herein. The computing device 55 may have a portable power supply 1455 such as a battery, which may be rechargeable. It may also have a sound and video module 1461 which assists in displaying video and sound and may turn off when not in use to conserve power and battery life. The computing device 55 may also have volatile memory 1465 and non-volatile memory 1471. The computing device 55 may have GPS capabilities that may be a separate circuit or may be part of the processor 1451. There also may be an input/output bus 1475 that shuttles data to and from the various user input/output devices such as a microphone, a camera, a display, or other input/output devices. The computing device 55 also may control communicating with networks either through wireless or wired devices. Of course, this is just one embodiment of a computing device 55 and the number and types of computing devices 55 is limited only by the imagination.

The physical elements that make up an embodiment of a server 57, such as dynamic graph application server 202, are further illustrated in FIG. 5. In some embodiments, the server 57 may be specially configured to run the dynamic loading graphical database disclosed herein. At a high level, the server 57 may include a digital storage such as a magnetic disk, an optical disk, flash storage, non-volatile storage, etc. Structured data may be stored in the digital storage database. More specifically, the server 57 may have a processor 1500 that is physically configured according to computer executable instructions. In some embodiments, the processor 1500 can be specially designed or configured to optimize communication between a computing device, such as computing device 55, and A/V equipment or external data sources 207 as described herein. The server 57 may also have a sound and video module 1505 which assists in displaying video and sound and may turn off when not in use to conserve power and battery life. The server 57 may also have volatile memory 1510 and non-volatile memory 1515.

The figures depict preferred embodiments for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer-implemented method for dynamically loading a graph database, the method comprising:
providing, by one or more processors, a query interface to one or more web clients over a communications network;
receiving, from at least one of the one or more web clients, a query via the query interface;
based on the query, executing, by the one or more processors, one or more external calls to one or more data sources;
implementing, by the one or more processors, one or more nodes-related methods to process node data from the one or more data sources;
implementing, by the one or more processors, one or more relationships-related methods to process relationship data from the one or more data sources;
performing, by the one or more processors, at least one of Create, Read, Update, Delete (CRUD) operation on data from the one or more data sources; and
constructing, by the one or more processors, a graph database based on the results of the at least one CRUD operation.

2. The method of claim 1, wherein the query interface complies with a graph query language specification.

3. The method of claim 2, wherein the graph query language specification is openCypher.

4. The method of claim 1, wherein executing the one or more external calls comprises accessing at least one of a relational database, a NoSQL database, or an external API.

5. The method of claim 1 further comprising storing the constructed graph database in non-persistent storage.

6. The method of claim 1, wherein the one or more external data sources are heterogeneous data sources.

7. The method of claim 1, wherein the one or more nodes-related methods and the one or more relationships-related methods implement lazy loading of objects in the graph database.

8. The method of claim 1, wherein the one or more external data sources have data rates of change that vary from one another.

9. The method of claim 1, wherein the external calls are data source agnostic.

10. The method of claim 1 further comprising sourcing data from the one or more external data sources only in response to receiving the query.

11. A non-transitory computer-readable storage medium containing instructions for a method of dynamically loading a graph database, the method comprising:
providing a query interface to one or more web clients over a communications network;
receiving, from at least one of the one or more web clients, a query via the query interface;
based on the query, executing one or more external calls to one or more data sources;
implementing one or more nodes-related methods to process node data from the one or more data sources;
implementing one or more relationships-related methods to process relationship data from the one or more data sources;
performing at least one of Create, Read, Update, Delete (CRUD) operation on data from the one or more data sources; and
constructing a graph database based on the results of the at least one CRUD operation.

12. The non-transitory computer-readable storage medium of claim 11, the method further comprising storing the constructed graph database in non-persistent storage.

13. The non-transitory computer-readable storage medium of claim 11, wherein the one or more external data sources are heterogeneous data sources.

14. The non-transitory computer-readable storage medium of claim 11, wherein the one or more nodes-related methods and the one or more relationships-related methods implement lazy loading of objects in the graph database.

15. The non-transitory computer-readable storage medium of claim 11, wherein the one or more external data sources have data rates of change that vary from one another.

16. The non-transitory computer-readable storage medium of claim 11, wherein the external calls are data source agnostic.

17. The non-transitory computer-readable storage medium of claim 11, the method further comprising sourcing data from the one or more external data sources only in response to receiving the query.

18. A computer-implemented method for dynamically loading a graph database, the method comprising:
receiving, from one or more web clients, an API request with a data payload including query data;
in response to receiving the API request, executing, by the one or more processors, one or more external calls to one or more to one or more heterogeneous data sources data sources based on the query data;
receiving, by the one or more processors, results of the one or more external calls;
constructing, by the one or more processors, a graph database based on the results of the one or more external calls;
storing, by the one or more processors, the graph database in non-persistent storage.

19. The method of claim 18 further comprising:
implementing, by the one or more processors, one or more nodes-related methods to process node data from the one or more data sources; and
implementing, by the one or more processors, one or more relationships-related methods to process relationship data from the one or more data sources.

20. The method of claim 18 further comprising sourcing data from the one or more external data sources only in response to receiving the query data.
